(19) United States
(12) Patent Application Publication
(10) Pub. No.: US 2024/0420662 A1
(43) Pub. Date: Dec. 19, 2024

(54) INFORMATION PROCESSING APPARATUS AND CONTROL METHOD

(71) Applicant: Lenovo (Singapore) Pte. Ltd., Singapore (SG)

(72) Inventors: Kazuhiro Kosugi, Kanagawa (JP); Masashi Nishio, Kanagawa (JP); Yuji Wada, Kanagawa (JP)

(73) Assignee: Lenovo (Singapore) Pte. Ltd., Singapore (SG)

(21) Appl. No.: 18/631,259

(22) Filed: Apr. 10, 2024

(30) Foreign Application Priority Data
Jun. 19, 2023 (JP) 2023-100076

(51) Int. Cl. G09G 5/10; G06T 7/20; G06V 40/16

(52) U.S. Cl. CPC G09G 5/10; G06T 7/20; G06V 40/161; G09G 2320/0626

(57) ABSTRACT

An information processing apparatus includes a memory which temporarily stores image data of an image captured by an imaging unit, a processor which processes the image data stored in the memory, an internal display, and a connection unit which connects to an external display. The processor performs face detection processing to process the image data of the image stored in the memory in order to detect a face area with a face captured therein and an angle of the face from the image, and brightness reduction processing to reduce screen brightness of either one or both of the internal display and the external display when the angle of the face detected by the face detection processing is out of a preset angle range.

### CROSS-REFERENCE TO RELATED APPLICATIONS

This application claims priority to Japanese Patent Application No. 2023-100076 filed on Jun. 19, 2023, the contents of which are hereby incorporated herein by reference in their entirety.

### BACKGROUND

### Technical Field

The present invention relates to an information processing apparatus and a control method.

### Description of the Related Art

There is an apparatus which makes a transition to a usable state when a person approaches or to a standby state in which functions except some of the functions are stopped when the person moves away. For example, in Japanese Unexamined Patent Application Publication No. 2016-148895, it is detected whether a person is approaching or has moved away using an infrared sensor.

In recent years, with the development of computer vision and the like, detection accuracy when detecting a face from an image has been getting higher. Therefore, person detection by face detection is also performed instead of person detection by the infrared sensor. In the person detection by face detection, since the orientation of a face can also be detected in addition to simply detecting a person, control according to whether or not the face is facing forward can also be performed. For example, there is an information processing apparatus (for example, a PC: Personal Computer) performs which screen brightness reduction processing to reduce the screen brightness of a display to save power or the like when the face is not facing forward (the direction of the apparatus) because it can be determined that a user the information processing apparatus.

For example, a laptop (clamshell) PC may be used by being connected to an external display. However, since a conventional PC only detects whether or not the face is facing forward (the direction of the PC), when a user is using the PC, for example, while looking at the external display, there is a concern that the screen brightness may be reduced because it is detected that the face is not facing forward (the direction of the PC). Therefore, when the external display is connected, the conventional PC disables the screen brightness reduction processing according to the face orientation described above. In recent years, since it has become possible to detect the face orientation (angle) in more detail, it is desired to apply the screen brightness reduction processing according to the face orientation described above even to the external display when the external display is connected to the PC.

### SUMMARY

One or more embodiments provide an information processing apparatus and a control method which perform screen brightness reduction processing according to the orientation of a face even when an external display is connected.

An information processing apparatus according to a first aspect of one or more embodiments includes: a memory which temporarily stores image data of an image captured by an imaging unit; a processor which processes the image data stored in the memory; an internal display; and a connection unit which connects to an external display, wherein the processor performs face detection processing to process the image data of the image stored in the memory in order to detect a face area with a face captured therein and an angle of the face from the image, and brightness reduction processing to reduce the screen brightness of either one or both of the internal display and the external display when the angle of the face detected by the face detection processing is out of a preset angle range, and a setting of the angle range used in the brightness reduction processing is different between a state where the external display is not connected to the connection unit and a state where the external display is connected to the connection unit.

The above information processing apparatus may be such that, in the brightness reduction processing in the state where the external display is not connected to the connection unit, when the angle of the face detected by the face detection processing is out of a preset first angle range, the processor reduces the screen brightness of the internal display, and in the brightness reduction processing in the state where the external display is connected, when the angle of the face detected by the face detection processing is out of a second angle range different from the first angle range, the processor reduces the screen brightness of the external display, while when the angle of the face detected by the face detection processing is out of the first angle range, the processor reduces the screen brightness of the internal display.

The above information processing apparatus may also be such that, in the brightness reduction processing in the state where the external display is not connected to the connection unit, when the angle of the face detected by the face detection processing is out of a preset first angle range, the processor reduces the screen brightness of the internal display, and in the state where the external display is connected, when the angle of the face detected by the face detection processing is out of a second angle range different from the first angle range, the processor reduces the screen brightness of the external display, while when the angle of the face detected by the face detection processing is out of the first angle range, the processor reduces the screen brightness of the internal display.

The above information processing apparatus may further be such that, in the brightness reduction processing in the state where the external display is not connected to the connection unit, when the angle of the face detected by the face detection processing is out of a preset first angle range, the processor reduces the screen brightness of the internal display, and in the state where the external display is connected to the connection unit and the external display does not conform to the brightness reduction processing, when the angle of the face detected by the face detection processing is out of a second angle range different from the first angle range, the processor reduces the screen brightness of the internal display.

Further, the above information processing apparatus may be such that the processor acquires position information indicative of the position of the external display connected to the connection unit relative to the internal display, and sets the second angle range based on the position information about the external display.

Further, the above information processing apparatus may be such that the processor sets the second angle range to widen the angle toward the position of the external display compared to the first angle range.

Further, the above information processing apparatus may be such that the processor sets the second angle range to narrow the angle in a direction opposite to the position of the external display compared to the first angle range.

Further, the above information processing apparatus may be such that predetermined angle ranges adjacent to the outside of the first angle range or the second angle range are set as third angle ranges, and when the angle of the face detected by the face detection processing is within either one of the third angle ranges, the processor reduces either one or both of the screen brightnesses of the internal display and the external display, and when the angle of the face is out of all of the first angle range, the second angle range, and the third angle ranges, the processor causes a system to make a transition to a standby state.

Further, the above information processing apparatus may be such that, when it is detected that the angle of the face is within the first angle range or the second angle range, the processor tracks the face area and the angle of the face in subsequent face detection processing to detect an angle of the face after being out of the first angle range or the second angle range.

Further, the above information processing apparatus may be such that, in the face detection processing, when determining that the reliability of the detection results of the face area and the angle of the face is a predetermined threshold value or more, the processor detects the face area and the face angle, and when detecting the angle of the face within either one of the third angle ranges, the processor lowers the threshold value used for determination of the reliability compared to when detecting the angle of the face within the first angle range or the second angle range.

Further, the above information processing apparatus may be such that, in the state where the external display is connected to the connection unit, when determining that the angle of the face is out of the second angle range or that no person is present based on the detection results by the face detection processing, the processor will control the brightness reduction processing to disabled if there is user input before a certain amount of time passes or the angle of the face falls within the second angle range before the certain amount of time passes.

Further, the above information processing apparatus may be such that, in the state where the external display is connected to the connection unit, when determining that the angle of the face is out of the second angle range or that no person is present based on the detection results by the face detection processing, the processor will lock the system if there is no user input and the angle of the face is out of the second angle range even after a certain amount of time has passed.

Further, a control method according to a second aspect of one or more embodiments is a control method for an information processing apparatus including: a memory which temporarily stores image data of an image captured by an imaging unit; a processor which processes the image data stored in the memory; an internal display; and a connection unit which connects to an external display, the control method including: a step of causing the processor to perform face detection processing to process the image data of the image stored in the memory in order to detect a face area with a face captured therein and an angle of the face from the image; and a step of causing the processor to perform brightness reduction processing to reduce the screen brightness of either one or both of the internal display and the external display when the angle of the face detected by the face detection processing is out of a preset angle range, wherein a setting of the angle range used in the brightness reduction processing is different between a state where the external display is not connected to the connection unit and a state where the external display is connected to the connection unit.

The above-described aspects of one or more embodiments can perform screen brightness reduction processing according to the face orientation properly even when the external display is connected.

### BRIEF DESCRIPTION OF THE DRAWINGS

FIG. 1 is a perspective view illustrating a configuration example of the appearance of an information processing apparatus according to one or more embodiments.

FIG. 2 is a diagram illustrating an example of a person detection range of the information processing apparatus according to one or more embodiments.

FIG. 3 is a diagram for describing an overview of HPD processing of the information processing apparatus according to one or more embodiments.

FIG. 4 is a diagram illustrating screen brightness reduction processing according to one or more embodiments.

FIG. 5 is a diagram illustrating an example of a state where the information processing apparatus according to one or more embodiments is connected to an external display and used.

FIG. 6 is a schematic diagram for describing a face angle detection method according to one or more embodiments.

FIG. 7 is a diagram illustrating angle range setting examples used for the determination of the screen brightness reduction processing according to one or more embodiments.

FIG. 8 is a schematic block diagram illustrating an example of the hardware configuration of the information processing apparatus according to one or more embodiments.

FIG. 9 is a schematic block diagram illustrating an example of the functional configuration of the information processing apparatus according to one or more embodiments.

FIG. 10 is a flowchart illustrating an example of face angle range setting processing in the screen brightness reduction processing according to one or more embodiments.

FIG. 11 is a flowchart illustrating an example of the screen brightness reduction processing according to one or more embodiments.

FIG. 12 is a flowchart illustrating an example of processing to deal with a presentation mode in screen brightness reduction processing according to one or more embodiments.

### DETAILED DESCRIPTION

Embodiments will be described below with reference to the accompanying drawings.

### First Example

### [Overview]

First, the overview of an information processing apparatus according to a first example will be described.

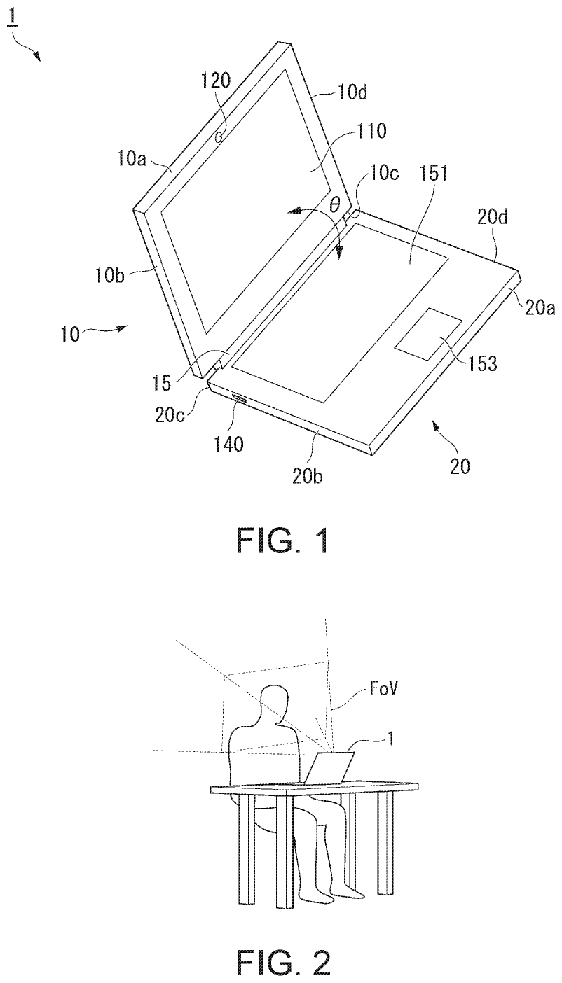

FIG. 1 is a perspective view illustrating a configuration example of the appearance of an information processing apparatus 1 according to one or more embodiments.

The information processing apparatus 1 is, for example, a laptop (clamshell) PC (Personal Computer). The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “θ” in FIG. 1.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c to the side face 20a is referred to as “front.” The right hand and left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0° is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the information processing apparatus 1 in FIG. 1 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when a user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15, or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can face a direction to face a display screen of the display unit 110.

In the open state, the imaging unit 120 images a predetermined imaging range in a direction to face the display screen of the display unit 110 (that is, in front of the information processing apparatus 1). The predetermined imaging range is a range of angles of view defined by an image sensor included in the imaging unit 120 and an optical lens provided in front of the imaging surface of the image sensor. For example, the imaging unit 120 can capture an image including a person (user) present in front of the information processing apparatus 1.

Further, a power button 140 is provided on the side face 20b of the second chassis 20. The power button 140 is an operating element used by the user to give an instruction to power on or power off, make a transition from a standby state to a normal operating state, make a transition from the normal operating state to the standby state, or the like. The normal operating state is an operating state of a system capable of executing processing without being particularly limited, which corresponds, for example, to S0 state defined in the ACPI (Advanced Configuration and Power Interface) specification.

The standby state is a state in which at least part of system processing is limited. For example, the standby state is a state in which the system is locked. In the state where the system is locked, an image preset to make a content being processed invisible (for example, an image for the lock) is displayed on the display unit. In order to unlock the system, user login authentication is required. Further, the standby state may be the standby state or a sleep state, Modern Standby in Windows (registered trademark), or a state corresponding to S3 state (sleep state) defined in the ACPI specification. For example, the standby state is a state lower in power consumption than the normal operating state.

Further, a keyboard 151 and a touch pad 153 are provided on the inner face of the second chassis 20 as an input device to accept user operation input. Note that a touch sensor may also be provided as the input device instead of or in addition to the keyboard 151 and the touch pad 153, or a mouse and an external keyboard may be connected. When the touch sensor is provided, an area corresponding to the display screen of the display unit 110 may be constructed as a touch panel to accept operations. Further, a microphone used to input voice may be included in the input device.

Note that in the closed state where the first chassis 10 and the second chassis 20 are closed, the display unit 110 and the imaging unit 120 provided on the inner face of the first chassis 10, and the keyboard 151 and the touch pad 153 provided on the inner face of the second chassis 20 are covered with each other's chassis faces, respectively, and put in a state of being disabled from fulfilling the functions.

The information processing apparatus 1 executes HPD (Human Presence Detection) processing to detect a person present in front of the information processing apparatus 1 based on a captured image captured by the imaging unit 120.

FIG. 2 is a diagram illustrating an example of a person detection range of the information processing apparatus 1 according to one or more embodiments. In the illustrated example, a detection range FoV (Field of View: detection viewing angle) in front of the information processing apparatus 1 is a person-detectable range.

The detection range FoV corresponds to an imaging angle of view at which the information processing apparatus 1 captures an image. For example, the information processing apparatus 1 detects a face area with a face captured therein and an angle of the face from a captured image captured by the imaging unit 120. For example, when the face area is detected from the captured image, the information processing apparatus 1 determines that a person is present. Further, the information processing apparatus 1 determines an orientation of the face based on the angle of the face detected from the captured image.

The information processing apparatus 1 controls the operating state of the system of the information processing apparatus 1 depending on the presence or absence of a person by the HPD processing. For example, when a person is present in front of the information processing apparatus 1, the information processing apparatus 1 controls the operating state to the normal operating state, while when no person is present in front of the information processing apparatus 1, the information processing apparatus 1 controls the operating state to the standby state.

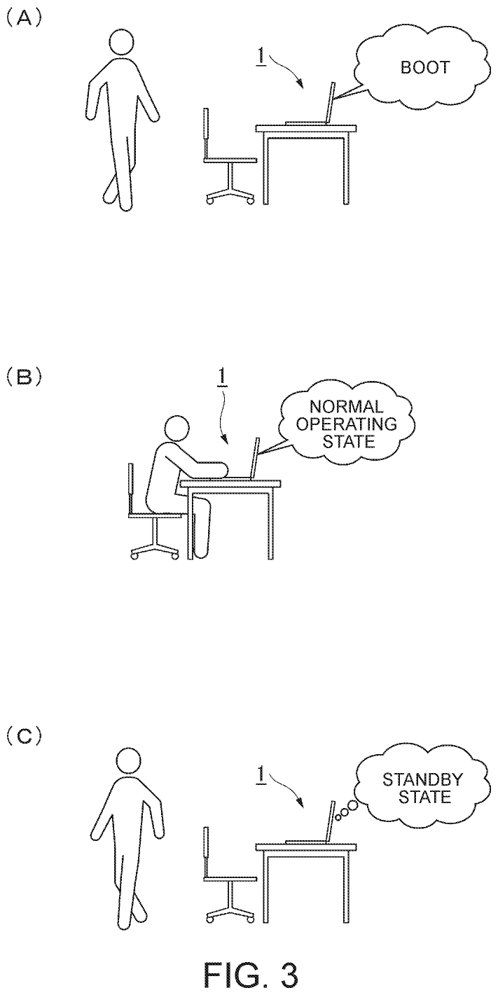

FIG. 3 is a diagram for describing an overview of the HPD processing of the information processing apparatus 1 according to one or more embodiments. The information processing apparatus 1 detects a person present in front of the information processing apparatus 1 by the HPD processing, and controls the operating state of the system of the information processing apparatus 1 based on the presence or absence of a person. For example, in the standby state, when detecting a change from a state where no person is present in front of the information processing apparatus 1 (Absence) to a state where a person is present (Presence), that is, when detecting that a person has approached the information processing apparatus 1 (Approach) as illustrated in (A) of FIG. 3, the information processing apparatus 1 automatically boots the system to make a transition to the normal operating state. Further, in a state where a person is present in front of the information processing apparatus 1 (Presence) in the normal operating state as illustrated in (B) of FIG. 3, the information processing apparatus 1 continues the normal operating state. Further, as illustrated in (C) of FIG. 3, when detecting a change from the state where the person is present in front of the information processing apparatus 1 (Presence) to the state where no person is present (Absence), that is, when detecting that the person has left the information processing apparatus 1 (Leave), the information processing apparatus 1 causes the system to make a transition to the standby state.

Further, in the HPD processing, the information processing apparatus 1 detects the angle of a face of the person present in front of the information processing apparatus 1 to determine an orientation of the face. When it can be determined that the person is not looking at the screen of the display unit 110, the information processing apparatus 1 reduces the screen brightness to save power. This processing to reduce the screen brightness by the HPD processing (Dimming processing) is called “screen brightness reduction processing” below.

In the following, the original screen brightness before being reduced is called “standard brightness,” and a screen brightness reduced from the standard brightness is called “low brightness.” The low brightness is a brightness at least lower than the standard brightness. However, the lower the brightness, the more the effect of power saving will increase. For example, the low brightness may be a brightness of about 0 to 10% of the standard brightness.

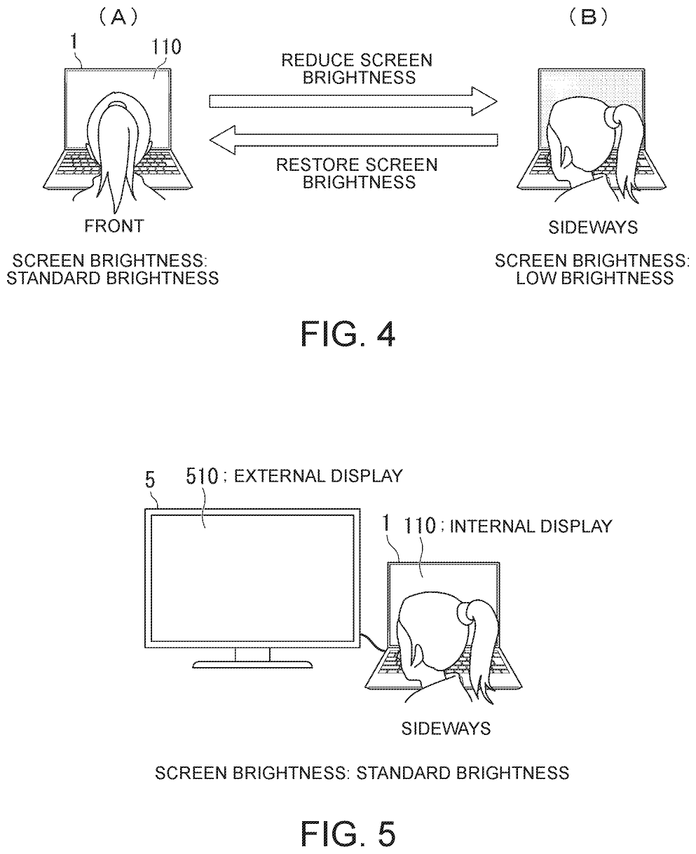

FIG. 4 is a diagram illustrating an example of screen brightness reduction processing according to one or more embodiments. For example, the information processing apparatus 1 determines whether or not the orientation of a face is facing the direction of the information processing apparatus 1 (the direction of the display unit 110 and the imaging unit 120) based on the angle of the face of a person (user) present in front of the information processing apparatus 1. The orientation of the face here is an orientation corresponding to a rotation angle of the face in the left and right direction or the up and down direction. In the following, a state where the face is facing the direction of the information processing apparatus 1 (the direction of the display unit 110 and the imaging unit 120) is a state where the orientation of the face is facing forward toward the information processing apparatus 1.

(A) of FIG. 4 illustrates a state where the orientation of a face is facing forward toward the information processing apparatus 1. In this state, it can be determined that the face is looking at the screen of the display unit 110. Therefore, the information processing apparatus 1 controls the screen brightness of the display unit 110 to the standard brightness. On the other hand, (B) of FIG. 4 illustrates a state where the orientation of the face is not facing forward toward the information processing apparatus 1 (for example, a state of being facing sideways). In this state, it can be determined that the face is not looking at the screen of the display unit 110. Therefore, when the orientation of the face changes from the state illustrated in (A) of FIG. 4 to the state illustrated in (B) of FIG. 4, the information processing apparatus 1 reduces the screen brightness of the display unit 110 from the standard brightness to the low brightness. Further, when the orientation of the face changes from the state illustrated in (B) of FIG. 4 to the state illustrated in (A) of FIG. 4, the information processing apparatus 1 restores the screen brightness of the display unit 110 from the low brightness to the standard brightness.

Here, the information processing apparatus 1 can be connected to an external display. For example, when the external display is not connected, the information processing apparatus 1 has only to perform the screen brightness reduction processing depending on whether or not the orientation of the face is facing forward toward the information processing apparatus 1 as illustrated in FIG. 4. However, when the external display is connected, the face may be facing toward the external display even if the orientation of the face is not facing forward toward the information processing apparatus 1.

FIG. 5 is a diagram illustrating an example of a state where the information processing apparatus 1 according to one or more embodiments is connected to an external display and used. In the illustrated example, the information processing apparatus 1 is connected to an external display device 5. The external display device 5 is configured to include a display unit 510 as an external display. As the connection method, any connection method using HDMI (registered trademark), USB Type-C, or a display port can be applied. Note that the information processing apparatus 1 may also be connected wirelessly to the external display device 5.

In the following description, the display unit 110 as an internal display included in the information processing apparatus 1 may be simply called the “internal display.” On the other hand, the display unit 510 as the external display included in the external display device 5 may be simply called the “external display.” As illustrated in FIG. 5, in a state where the information processing apparatus 1 is connected to the external display and used, when the orientation of the face is facing toward the external display, the state becomes a state where the face is not facing forward toward the internal display (the information processing apparatus 1) (for example, a state of being sideways). However, since the user is using the information processing apparatus 1, it is desired to maintain the standard brightness without reducing the screen brightness. Conventionally, since the detection accuracy of the orientation of the face is such a detection accuracy as to determine whether or not the face is facing forward, the screen brightness reduction processing is disabled when the external display is connected in order to maintain the standard brightness without reducing the screen brightness.

However, the face orientation detection accuracy has improved in recent years. For example, it is possible to detect the face angle with an accuracy of every 10°. Therefore, the information processing apparatus 1 uses the fact that face angle detection accuracy has been improved to support the screen brightness reduction processing even in the state where the external display is connected in addition to the state where the external display is not connected.

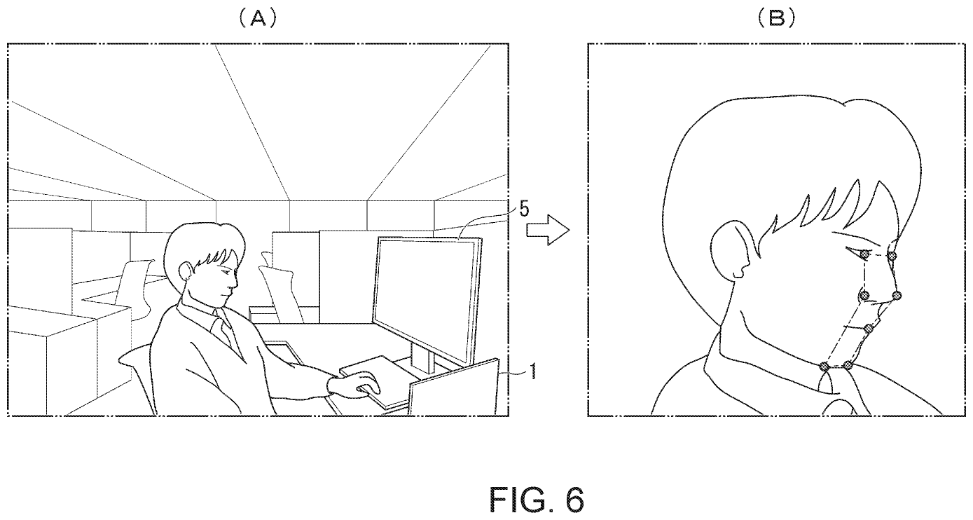

FIG. 6 is a schematic diagram for describing a face angle detection method according to one or more embodiments. (A) of FIG. 6 illustrates a state where an external display (the external display device 5) is connected to the information processing apparatus 1. In this state, since the orientation of a face is facing the direction of the external display, a sideways face is captured from the information processing apparatus 1. (B) of FIG. 6 illustrates an enlarged face area of the captured image. In face detection processing, the information processing apparatus 1 extracts not only simply pattern matching with the face image but also landmark positions, such as left eye, right eye, nose, mouth, and chin of the face, to detect the angle of the face from the positional relationship. In (B) of FIG. 6, an example of the landmark positional relationship is schematically represented by points and lines.

When the angle of the face detected by the face detection processing is out of a preset angle range, the information processing apparatus 1 reduces the screen brightnesses of the internal display and the external display to the low brightness. The preset angle range is a range of face angles in which it is determined that the face is looking at the screen. In the state where the external display is not connected, the preset angle range is a range of face angles in which it is determined that the face is facing forward toward the information processing apparatus 1 (it is determined that the face is looking at the internal display). This angle range used for the determination of the screen brightness reduction processing is set differently between the state where the external display is not connected and the state where the external display is connected.

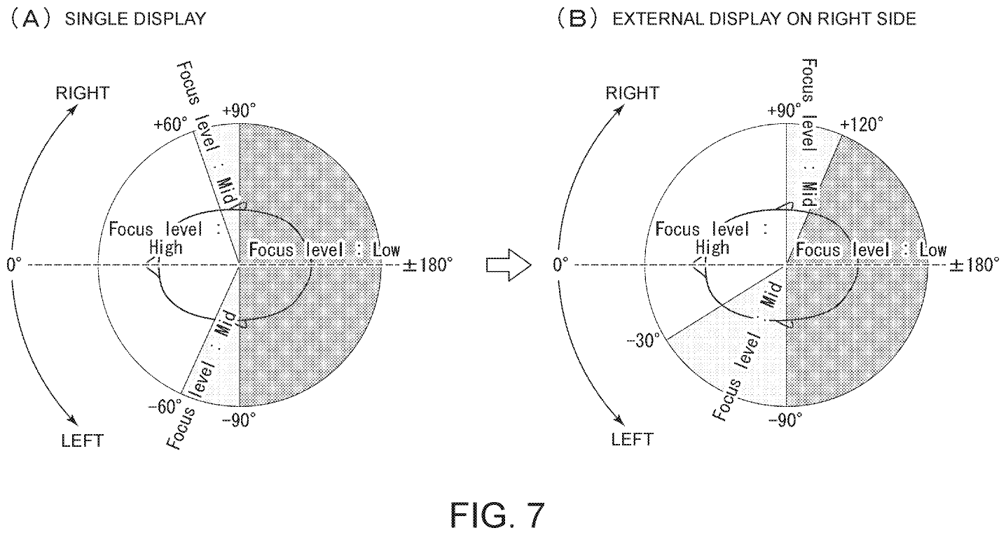

FIG. 7 is a diagram illustrating angle range setting examples used for the determination of the screen brightness reduction processing according to one or more embodiments. (A) of FIG. 7 illustrates a setting example of angle ranges relative to changes in face orientation in the yaw direction (left and right direction) in a state where only the internal display is used without the external display being connected (single display). Here, an angle from the face toward the information processing apparatus 1 (a face angle when facing completely forward toward the information processing apparatus 1) is set to 0°. Then, changes in face orientation to the right are represented as angle changes in the positive (+) direction, and changes in face orientation to the left are represented as angle changes in the negative (−) direction.

Here, an evaluation value determined to be looking at the internal display is represented as a “focus level.” An angle range that can be determined to be looking at the internal display is set to a focus level “High,” either one of angle ranges adjacent to the outside of the focus level “High” is set to a focus level “Mid (Middle)” as an angle range to reduce the screen brightness. Further, an angle range further out of the focus level “Mid” and in which it seems like the face is facing backward is set to a focus level “Low.” The focus level “Low” may be treated in the same way as the state where the person has left (Leave).

As illustrated in (A) of FIG. 7, in the state where the external display is not connected (single display), for example, a range of “−60° to +600” is set to the focus level “High,” ranges of “+60° to +90°” and “−60° to −90°” are set to the focus level “Mid,” and the remaining range of “+90° to +180°” and “−90° to −180°” is set to the focus level “LOW.”

In the screen brightness reduction processing in the state without the external display being connected, when the angle of the face detected by the face detection processing is out of the angle range (“−60° to +60°”) of the focus level “High,” that is, when the angle of the face falls within either one of the angle ranges of the focus levels “Mid,” the information processing apparatus 1 reduces the screen brightness of the internal display. Further, when the angle of the face detected by the face detection processing is further out of the angle range of the focus levels “Mid,” the information processing apparatus 1 may cause the system to make the transition to the standby state (for example, to lock the system) in the same way as when “Leave” is detected.

(B) of FIG. 7 illustrates a setting example of angle ranges relative to changes in face orientation in the yaw direction (left and right direction) when the external display is placed on the right side of the information processing apparatus 1 in the state where the external display is connected. In the state where the external display is connected, the angle ranges are set differently from the angle ranges illustrated in (A) of FIG. 7. For example, in the state where the external display is connected, the angle ranges are set differently from the angle ranges illustrated in (A) of FIG. 7 based on the position of the external display.

Specifically, in the state where the external display is connected, the angle range of the focus level “High” is set to a range of “−30° to +90°” to widen the angle toward the position of the external display (here, on the right side) and to narrow the angle in a direction opposite to the position of the external display (here, on the left side) compared to the angle range of “−60° to +60°” illustrated in (A) of FIG. 7. Further, in the state where the external display is connected, the angle ranges of the focus level “Mid” are set to ranges of “+90° to +120°” and “−30° to −90°,” and the angle range of the focus level “Low” is set to the remaining range of “+120° to +180°” and “−90° to −180°.”

Thus, since the angle range of the focus level “High” is widened toward the position of the external display, it becomes difficult for the angle of the face to be out of the focus level “High” even when the face orientation changes in the direction toward the external display. Therefore, even in the state where the external display is connected, since the screen brightness is suppressed from being reduced when the user is using the information processing apparatus 1 while looking at the external display, the screen brightness reduction processing can be applied.

In the following, the settings of angle ranges (for example, the settings illustrated in (A) of FIG. 7) in the state where the external display is not connected (single display) are called “reference angle ranges.” On the other hand, the settings of angle ranges (for example, the settings illustrated in (B) of FIG. 7) in the state where the external display is connected are called “extended angle ranges.”

Note that, in the extended angle ranges, settings of plural kinds of angle ranges according to the position of the external display are included. The extended angle ranges illustrated in (B) of FIG. 7 are the angle range settings when the external display is placed to the right of the information processing apparatus 1. On the other hand, in the extended angle ranges when the external display is placed to the left of the information processing apparatus 1, the angle range of the focus level “High” is set to widen to the left.

For example, when the external display is placed to the left of the information processing apparatus 1, the angle range of the focus level “High” is set to a range of “−90° to +30°” in which the angle to the left is widened and the angle to the right is narrowed. Further, the angle ranges of the focus level “Mid” are set to ranges of “+30° to +90°” and “−90° to −120°,” and the angle range of the focus level “Low” is set to the remaining range of “+90° to +180°” and “−120° to −180°.”

Here, as described above, the angle ranges of the focus level “Mid” may enter the side of “+180°” beyond “+90°” or “−90°.” On the other hand, the range to the side of “0” beyond “+90°” or “−90°” is never included in the angle range of the focus level “Low.”

Further, in the settings of the extended angle ranges illustrated in (B) of FIG. 7, the angle range of the focus level “High” is so set that the angle toward the position of the external display is widened and the angle in the direction opposite to the position of the external display is narrowed compared to the settings of the reference angle ranges illustrated in (A) of FIG. 7, but the angle in the direction opposite to the position of the external display does not have to be narrowed. For example, in the settings of the extended angle ranges illustrated in (B) of FIG. 7, the angle range of the focus level “High” may also be set to a range of “−60° to +90°.” In this case, the angle ranges of the focus level “Mid” are set, for example, to ranges of “+90° to +1200” and “−60° to −90°.” The extended angle ranges when the external display is placed to the left of the information processing apparatus are also set in the same way. For example, the angle range of the focus level “High” may be set to a range of “−90° to +30°,” or to a range “−90° to +60°.”

Further, although the setting examples of angle ranges relative to changes in face orientation in the yaw direction (left and right direction) are described with reference to FIG. 7, the settings of angle ranges relative to changes in face orientation in the pitch direction (up and down direction) when the external display is placed above or below the information processing apparatus 1 can also be handled in the same way by replacing left and right with up and down.

The configurations of the information processing apparatus 1 according to one or more embodiments will be described in detail below.

### [Hardware Configuration of Information Processing Apparatus]

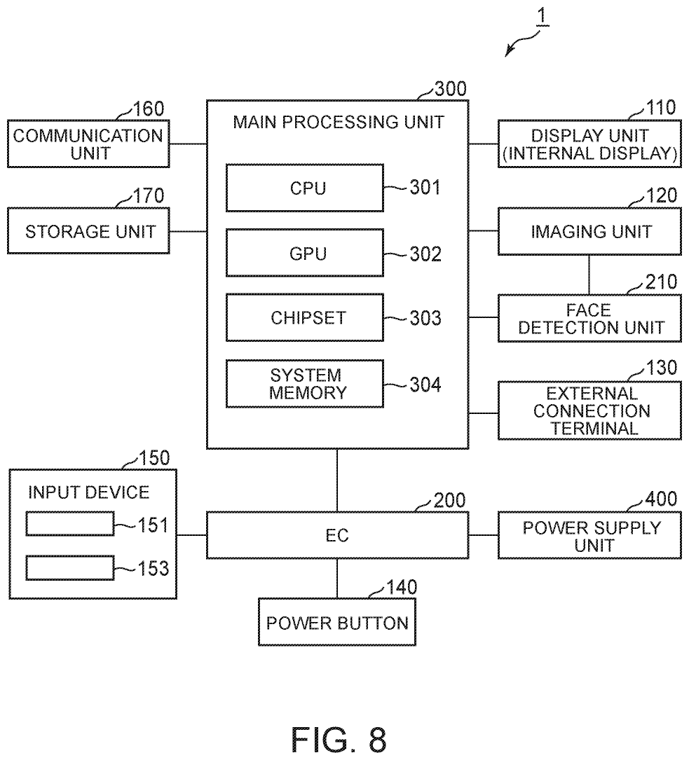

FIG. 8 is a schematic block diagram illustrating an example of the hardware configuration of the information processing apparatus 1 according to one or more embodiments. In FIG. 8, components corresponding to respective units in FIG. 1 are given the same reference numerals. The information processing apparatus 1 is configured to include the display unit 110, the imaging unit 120, an external connection terminal 130, the power button 140, the input device 150, a communication unit 160, a storage unit 170, an EC (Embedded Controller) 200, a face detection unit 210, a main processing unit 300, and a power supply unit 400.

The display unit 110 (internal display) displays display data (images) generated based on system processing executed by the main processing unit 300, processing of an application program running on the system processing, and the like.

The imaging unit 120 captures an image of an object within the predetermined imaging range (angle of view) in the direction (frontward) to face the inner face of the first chassis 10, and outputs the captured image to the main processing unit 300 and the face detection unit 210. For example, the imaging unit 120 includes a visible light camera (RGB camera) for capturing an image using visible light and an infrared camera (IR camera) for capturing an image using infrared light.

Note that the imaging unit 120 may be configured to include either one of the visible light camera and the infrared camera, or may be configured to include both the visible light camera and the infrared camera.

The external connection terminal 130 is a connection terminal used to connect to the external display device 5 (external display). For example, the external connection terminal 130 is an HDMI (registered trademark) terminal, a USB Type-C terminal, a display port, or the like. Note that the information processing apparatus 1 and the external display device 5 may also be connected wirelessly.

The power button 140 outputs, to the EC 200, an operation signal according to a user operation. The input device 150 is an HID (input unit) for accepting user input, which is configured to include, for example, the keyboard 151 and the touch pad 153. In response to accepting operations on the keyboard 151 and the touch pad 153, the input device 150 outputs, to the EC 200, operation signals indicative of operation contents.

The communication unit 160 is connected to other devices communicably through wireless a or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM, and a ROM. The storage unit 170 stores an OS, device drivers, various programs such as applications, and various data acquired by the operation of the programs.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the functionality. The EC 200 operates independently of the main system processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The face detection unit 210 is configured to include a processor for processing image data of a captured image captured by the imaging unit 120. The face detection unit 210 acquires the image data of the captured image captured by the imaging unit 120, and temporarily stores the acquired image data in a memory. The memory in which the image data is stored may be a system memory 304, or an unillustrated memory in the face detection unit 210.

For example, the face detection unit 210 processes the image data of the captured image acquired from the imaging unit 120 to perform face detection processing for detecting a face area (an area of a face image) and a face angle from the captured image.

Further, based on the detection results of the face area and the face angle detected in the face detection processing, the face detection unit 210 outputs the detection results by the HPD processing. For example, the face detection unit 210 outputs, to the main processing unit 300, the detection results based on the presence or absence of a person and the orientation of a face.

The main processing unit 300 is configured to include a CPU (Central Processing Unit) 301, a GPU (Graphic Processing Unit) 302, a chipset 303, and the system memory 304, where processing of various application programs is executable on the OS (Operating System) by system processing based on the OS.

The CPU 301 is a processor which executes processing based on a BIOS program, processing based on the OS program, processing based on application programs running on the OS, and the like. For example, the CPU 301 executes boot processing to boot the system from the standby state and make the transition to the normal operating state, sleep processing to make the transition from the normal operating state to the standby state, and the like. Further, the CPU 301 executes screen brightness reduction processing to reduce the screen brightness of the display unit 110 (internal display) based on the results of the face detection processing by the face detection unit 210 described above, and the like.

The GPU 302 is connected to the display unit 110 (internal display). The GPU 302 executes image processing under the control of the CPU 301 to generate display data. The GPU 302 outputs the generated display data to the display unit 110 (internal display). Further, when the external display device 5 (external display) is connected, the display data generated by the GPU 302 is also output to the external display device 5 (external display), for example, through the external connection terminal 130.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110 (internal display), and the EC 200. Further, the chipset 303 has a function as a sensor hub. For example, the chipset 303 acquires the detection results by the face detection processing acquired from the face detection unit 210, and outputs the acquired detection results to the CPU 301.

The system memory 304 is used as a reading area of a program executed by the CPU 301 and a working area to write processed data. Further, the system memory 304 temporarily stores image data of a captured image captured by the imaging unit 120.

Note that the CPU 301, the GPU 302, and the chipset 303 may be integrated as one processor, or some or each of them may be configured as an individual processor, respectively. For example, in the normal operating state, the CPU 301, the GPU 302, and the chipset 303 are all operating, but in the standby state, only at least some of the functions of the chipset 303 are operating.

### [Functional Configuration of Information Processing Apparatus]

Next, the functional configuration of the information processing apparatus 1 to control the screen brightness according to the face orientation will be described in detail.

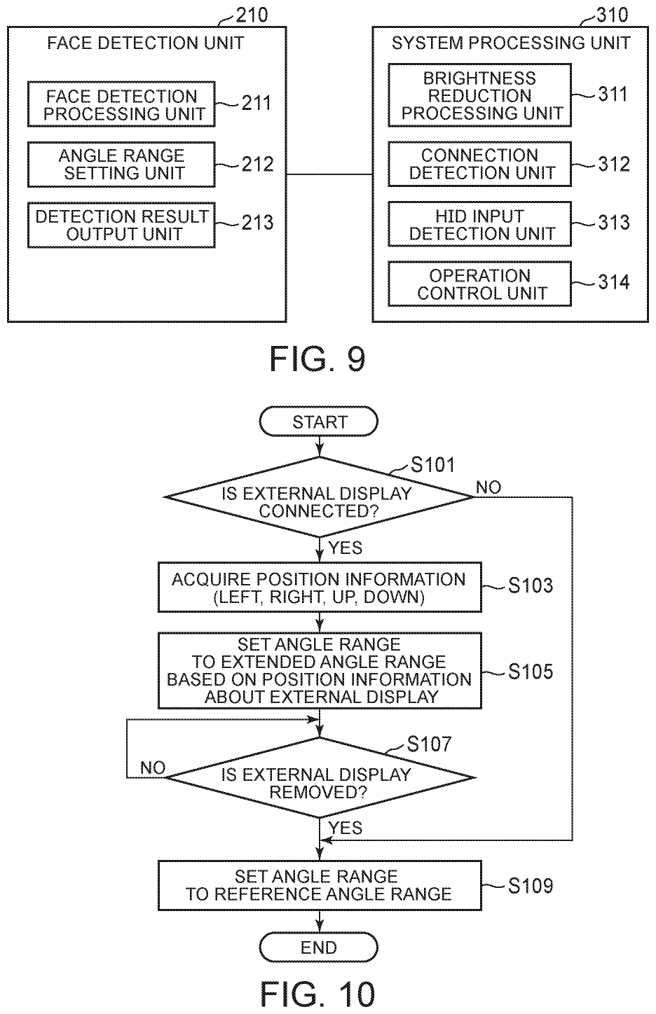

FIG. 9 is a schematic block diagram illustrating an example of the functional configuration of the information processing apparatus 1 according to one or more embodiments. The information processing apparatus 1 includes the face detection unit 210 and a system processing unit 310. The face detection unit 210 corresponds to the face detection unit 210 in FIG. 8, and includes a face detection processing unit 211, an angle range setting unit 212, and a detection result output unit 213 as functional components to perform the face detection processing.

The face detection processing unit 211 processes image data of a captured image acquired from the imaging unit 120 to detect a face area with a face captured therein (an area of a face image) from the captured image. As the face detection method, any detection method using a face detection algorithm for detecting a face based on facial feature information, trained data (learned model) subjected to machine learning based on the facial feature information, a face detection library, or the like can be applied. Further, the face detection unit 210 extracts landmark positions, such as left eye, right eye, nose, mouth, and chin of the face, as described with reference to FIG. 6 to detect the angle of the face from the positional relationship. The angle of the face is detected as an angle in the yaw direction (left and right direction) and the pitch direction (up and down direction) from a reference direction set, for example, to 0°. For example, as illustrated in FIG. 7, the reference direction is the direction from the face toward the direction of the information processing apparatus 1 (the direction of the display unit 110 and the imaging unit 120).

Further, when detecting the angle of the face, the face detection processing unit 211 tracks the detected face angle. For example, when the detected face angle is within the angle range of the focus level “High,” the face detection processing unit 211 tracks face areas and face angles in subsequent face detection processing to detect a face angle after going out of the angle range of the focus level “High.” Thus, the face detection processing unit 211 can also detect face angles that fall into the angle ranges of the focus level “Mid” and the focus level “Low” by tracking the face angles.

Further, in the face detection processing, when it is determined that the reliability of the detection results of the face area and the face angle is a predetermined threshold value or more, the face detection processing unit 211 detects the face area and the face angle. Then, when detecting face angles within the angle ranges of the focus level “Mid” and the focus level “Low,” the face detection processing unit 211 lowers the threshold value used for the determination of the reliability compared to when detecting the face angle within the angle range of the focus level “High.”

The angle range setting unit 212 sets an angle range used for determining the face angle in the screen brightness reduction processing depending on whether or not the external display (external display device 5) is connected. For example, the angle range setting unit 212 acquires, from the system processing unit 310, information about whether or not the external display is connected to the information processing apparatus 1. Then, the angle range setting unit 212 sets the angle range to a reference angle range in the state where the external display is not connected, or sets the angle range to an extended angle range in the state where the external display is connected.

Further, in the state where the external display is connected, the angle range setting unit 212 acquires position information on the connected external display. For example, the angle range setting unit 212 acquires, from the system processing unit 310, the position information on the external display set in the system display settings. In the system display settings, position information indicative of the position (right, left, up, or down) of the external display relative to the internal display of the information processing apparatus 1 is set. When the user actually places and uses the external display, this display setting can be changed by an operation according to the arrangement.

Then, when setting the angle range to the extended angle range in the state where the external display is connected, the angle range setting unit 212 sets the extended angle range based on the position information about the external display. For example, the angle range setting unit 212 sets the extended angle range of the focus level “High” so that the angle is widened toward the position of the external display compared to the reference angle range of the focus level “High.” As an example, when the position of the external display is on the right, the angle range setting unit 212 sets the extended angle range of the focus level “High” (see (B) of FIG. 7) to widen the angle to the right compared to the reference angle range of the focus level “High” (see (A) of FIG. 7).

Further, the angle range setting unit 212 may also set the extended angle range of the focus level “High” to narrow the angle in the direction opposite to the position of the external display compared to the reference angle range of the focus level “High.” As an example, when the position of the external display is on the right, the angle range setting unit 212 sets the extended angle range of the focus level “High” (see (B) of FIG. 7) to narrow the angle to the left compared to the reference angle range of the focus level “High” (see (A) of FIG. 7).

The detection result output unit 213 outputs the detection results of the HPD processing based on the detection results of the face area and the face angle by the face detection processing unit 211, and the reference angle range or the extended angle range set by the angle range setting unit 212. For example, when a face area is detected from a captured image by the face detection processing unit 211, the detection result output unit 213 determines that a person is present and outputs “Presence” information. Further, when no face area is detected from the captured image by the face detection processing unit 211, the detection result output unit 213 determines that no person is present and outputs “Absence” information. Further when a face area is detected from a state where no face area is detected from the captured image by the face detection processing unit 211, the detection result output unit 213 determines that a person has approached and outputs “Approach” information. Further, when the face area is no longer detected from a state where the face area is detected from the captured image by the face detection processing unit 211, the detection result output unit 213 determines that the person has left and outputs “Leave” information.

Further, in the state where it is determined that the person is present, the detection result output unit 213 outputs information indicative of whether or not the user is looking at (paying attention to) the screen based on the face angle. For example, when determining that the angle of the face detected by the face detection processing unit 211 is within the angle range of the focus level “High” in the reference angle ranges or the extended angle ranges set in the angle range setting unit 212, the detection result output unit 213 outputs, to the system processing unit 310, “Attention” information as information indicative of a state of looking at (paying attention to) the screen. On the other hand, when determining that the angle of the face detected by the face detection processing unit 211 is within an angle range of the focus level “Mid” in the reference angle ranges or the extended angle ranges set in the angle range setting unit 212, the detection result output unit 213 outputs, to the system processing unit 310, “No Attention” information as information indicative of a state of not looking at (not paying attention to) the screen.

Note that, when determining that the angle of the face detected by the face detection processing unit 211 is within the angle range of the focus level “Low” in the reference angle ranges or the extended angle ranges set in the angle range setting unit 212, the detection result output unit 213 may continuously output the “No Attention” information or the “Leave” information to the system processing unit 310.

The system processing unit 310 is a functional component implemented by the CPU 301 or the chipset 303 executing the system program or a program for the HPD processing. For example, the system processing unit 310 includes a brightness reduction processing unit 311, a connection detection unit 312, an HID input detection unit 313, and an operation control unit 314 as functional components implemented by executing the OS program.

The brightness reduction processing unit 311 executes the screen brightness reduction processing to reduce the screen brightnesses of the internal display and the external display based on the orientation of the face detected by the face detection unit 210. Note that the external display to which the screen brightness reduction processing can be applied is an external display conforming to the standards for controlling the screen brightness of the external display from the information processing apparatus 1.

For example, in the normal operating state, when the “No Attention” information is acquired from the face detection unit 210, that is, when the face angle enters an angle range of the focus level “Mid” out of the focus level “High,” the brightness reduction processing unit 311 performs control to reduce the screen brightness to the low brightness.

Further, in the state where the screen brightness is controlled to the low brightness, when the “Attention” information is acquired from the face detection unit 210, that is, when the face angle returns to the angle range of the focus level “High,” the brightness reduction processing unit 311 restores the screen brightness to the standard brightness before being reduced.

Further, the brightness reduction processing unit 311 is equipped with a timer for measuring time to measure a waiting time from when the “No Attention” information is acquired from the face detection unit 210 until the screen brightness is controlled to the low brightness in the normal operating state. For example, even after the “No Attention” information is acquired, when the “Attention” information is acquired before a predetermined waiting time elapses, the brightness reduction processing unit 311 leaves the screen brightness at the standard brightness without controlling the screen brightness to the low brightness. On the other hand, after the “No Attention” information is acquired, when the “Attention” information is not acquired until the predetermined waiting time elapses, the brightness reduction processing unit 311 controls the screen brightness to the low brightness. This makes it possible to prevent the screen brightness from being controlled to the low brightness when the user just looks away a little while using the information processing apparatus 1. The predetermined waiting time is preset, for example, to 10 seconds. Note that this predetermined waiting time may also be settable by the user.

The connection detection unit 312 detects whether or not the external display device 5 (external display): is connected through the external connection terminal 130. The connection detection unit 312 outputs, to the face detection unit 210, the detection result of whether or not the connection to the external display device 5 is established.

The HID input detection unit 313 detects user input to an HID (Human Interface Device) such as the keyboard 151, the touch pad 153, or the like (hereinafter called “HID input”). For example, the HID input detection unit 313 detects HID input through the EC 200 to which operation signals from the keyboard 151 and the touch pad 153 are input. Note that HID input is not limited to input to the keyboard 151 or the touch pad 153, and it may also be input using an external keyboard or a mouse, or voice input to an unillustrated microphone.

For example, when detecting HID input, the HID input detection unit 313 outputs, to the brightness reduction processing unit 311, information indicating that HID input is detected. When there is HID input in the state where the screen brightness is controlled to the low brightness, since the brightness reduction processing unit 311 can determine that the user is using the information processing apparatus 1, the screen brightness may be restored to the standard brightness before being reduced.

The operation control unit 314 controls the operating state of the system. For example, when the power button 140 is operated in the standby state, the operation control unit 314 boots the system from the standby state based on an operation signal acquired from the power button 140 through the EC 200. Further, the operation control unit 314 performs processing such as system shutdown, transition to the standby state, reboot, or the like based on an operation on a power menu (shutdown, sleep, reboot, or the like) of the OS displayed on the display unit 110 in the normal operating state.

Further, the operation control unit 314 controls the operating state of the system by the HPD processing. For example, when the “Approach” information is acquired from the face detection unit 210 in the standby state, the operation control unit 314 boots the system from the standby state. Further, when the “Leave” information is acquired from the face detection unit 210 in the normal operating state, the operation control unit 314 makes the transition to the standby state after a certain amount of time has passed.

### [Operation of Face Angle Range Setting Processing]

Referring next to FIG. 10, the operation of face angle range setting processing to set an angle range used by the angle range setting unit 212 of the face detection unit 210 to determine a face angle in the screen brightness reduction processing will be described.

FIG. 10 is a flowchart illustrating an example of face angle range setting processing in the screen brightness reduction processing according to one or more embodiments.

(Step S101) The angle range setting unit 212 acquires, from the system processing unit 310, information about whether or not the external display is connected to the information processing apparatus 1 to determine whether or not the external display is connected. When determining that the external display is not connected (NO), the angle range setting unit 212 proceeds to a process in step S109 to set the angle range to a reference angle range (see (A) of FIG. 7). On the other hand, when determining that the external display is connected (YES), the angle range setting unit 212 proceeds to a process in step S103.

(Step S103) In the state where the external display is connected to the information processing apparatus 1, the angle range setting unit 212 acquires, from the system processing unit 310, position information (left, right, up, down) on the connected external display. Then, the angle range setting unit 212 proceeds to a process in step S105.

(Step S105) The angle range setting unit 212 sets the angle range to an extended angle range based on the position information about the external display. For example, the angle range setting unit 212 sets the extended angle range of the focus level “High” so that the angle is widened toward the position of the external display compared to the reference angle range of the focus level “High.” As an example, when the position of the external display is on the right, the angle range setting unit 212 sets the extended angle range of the focus level “High” (see (B) of FIG. 7) to widen the angle to the right compared to the reference angle range of the focus level “High” (see (A) of FIG. 7).

Further, the angle range setting unit 212 may also set the extended angle range of the focus level “High” to narrow the angle in the direction opposite to the position of the external display compared to the reference angle range of the focus level “High.” As an example, when the position of the external display is on the right, the angle range setting unit 212 sets the extended angle range of the focus level “High” (see (B) of FIG. 7) to narrow the angle to the left compared to the reference angle range of the focus level “High” (see (A) of FIG. 7). Then, the angle range setting unit 212 proceeds to a process in step S107.

(Step S107) The angle range setting unit 212 acquires, from the system processing unit 310, the information about whether or not the external display is connected to the information processing apparatus 1 at predetermined intervals to determine whether or not the external display is removed. When determining that the external display is not removed (NO), the angle range setting unit 212 performs this process in step S107 again. On the other hand, when determining that the external display is removed (YES), the angle range setting unit 212 proceeds to the process in step S109.

(Step S109) When the external display becomes such a state as not to be connected, the angle range setting unit 212 restores the setting to the setting of the reference angle range (see (A) of FIG. 7).

### [Operation of Screen Brightness Reduction Processing]

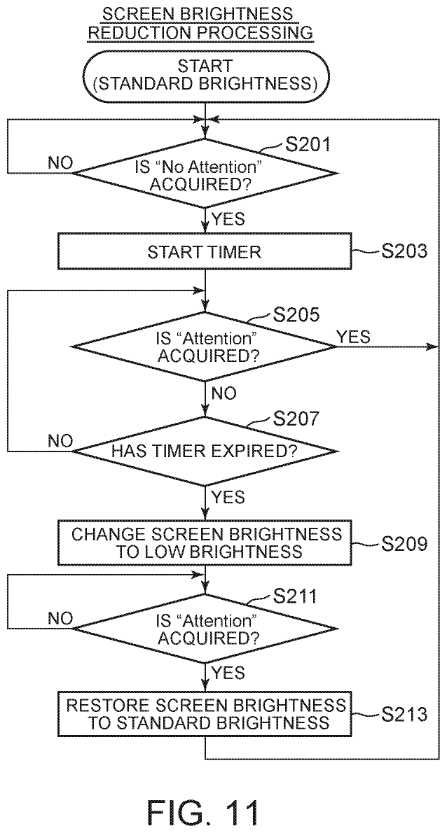

Referring next to FIG. 11, the operation of screen brightness reduction processing executed by the brightness reduction processing unit 311 will be described. FIG. 11 is a flowchart illustrating an example of screen brightness reduction processing according to one or more embodiments. Here, it is assumed that the information processing apparatus 1 is in the normal operating state and the screen brightness is set to the standard brightness.

The brightness reduction processing unit 311 performs screen brightness reduction processing depending on whether the “Attention” information or the “No Attention” information is acquired from the face detection unit 210. In the state where the external display is not connected, the face detection unit 210 determines the face angle using the reference angle ranges the “Attention” information or the “No Attention” information. On the other hand, in the state where the external display is connected, the face detection unit 210 determines the face angle using the extended angle ranges to output the “Attention” information or the “No Attention” information.

(Step S201) The brightness reduction processing unit 311 determines whether or not the “No Attention” information is acquired from the face detection unit 210. When determining that the “No Attention” information is not acquired (NO), the brightness reduction processing unit 311 performs the process in step S201 again. On the other hand, when determining that the “No Attention” information is acquired (YES), the brightness reduction processing unit 311 starts measuring the waiting time using the timer (step S203). Then, the brightness reduction processing unit 311 proceeds to a process in step S205.

(Step S205) The brightness reduction processing unit 311 determines whether or not the “Attention” information is acquired from the face detection unit 210. When determining that not acquired (NO), the brightness reduction processing unit 311 proceeds to a process in step S207.

(Step S207) The brightness reduction processing unit 311 determines whether or not a certain amount of time (for example, 10 seconds) has passed (that is, whether or not the timer has expired) based on the timer value. When determining that the certain amount of time (for example, 10 seconds) has not passed (that is, the timer has not expired) (step S207: NO), the brightness reduction processing unit 311 returns to the process in step S205. When determining that the “Attention” information is acquired before the certain amount of time (for example, 10 seconds) passes (step S205: YES), the brightness reduction processing unit 311 returns to the process in step S201. At this time, the timer is reset.

On the other hand, when determining in step S207 that the waiting time (for example, 10 seconds) has passed (step S207: YES), the brightness reduction processing unit 311 proceeds to a process in step S209.

(Step S209) The brightness reduction processing unit 311 changes the screen brightness from the standard brightness to the low brightness. Then, the brightness reduction processing unit 311 proceeds to a process in step S211.

(Step S211) The brightness reduction processing unit 311 determines whether or not the “Attention” information is acquired from the face detection unit 210. When determining that the “Attention” information is not acquired (NO), the brightness reduction processing unit 311 performs the process in step S211 again. On the other hand, when determining that the “Attention” information is acquired (YES), the brightness reduction processing unit 311 restores the screen brightness to the standard brightness (step S213).

### [Summary of First Example]

As described above, the information processing apparatus 1 according to one or more embodiments includes: a memory (for example, the system memory 304) which temporarily stores image data of a captured image captured by the imaging unit 120; an internal display (for example, the display unit 110); and the external connection terminal 130 (an example of a connection unit) which connects to an external display (for example, the display unit 510 of the external display device 5). Further, the information processing apparatus 1 includes the face detection unit 210, the CPU 301, the chipset 303, and the like as an example of a processor.

The information processing apparatus 1 processes the image data of the captured image stored in the above memory to execute face detection processing to detect a face area with a face captured therein and an angle of the face from the captured image. Further, when the angle of the face detected by the above face detection processing is out of a preset angle range (for example, the angle range of the focus level “High”), the information processing apparatus 1 performs screen brightness reduction processing (an example of brightness reduction processing) to reduce the screen brightnesses of the internal display and the external display. Then, the setting of the above angle range (for example, the angle range of the focus level “High”) used for the above screen brightness reduction processing is different between a state where the external display is not connected to the external connection terminal 130 and a state where the external display is connected to the external connection terminal 130.

Thus, since the information processing apparatus 1 changes the threshold value of the face angle (angle range) for reducing the screen brightness between the state where the external display is not connected and the state where the external display is connected, the screen brightness reduction processing according to the face orientation can be performed properly even when the external display is connected.

For example, in the brightness reduction processing in the state where the external display is not connected to the external connection terminal 130, when the face angle detected by the face detection processing is out of the angle range of the focus level “High” in preset reference angle ranges (an example of a first angle range), the information processing apparatus 1 reduces the screen brightness of the internal display. Further, in the screen brightness reduction processing in the state where the external display is connected to the external connection terminal 130, when the face angle detected by the face detection processing is out of the angle range of the focus level “High” as an extended angle range (an example of a second angle range different from the first angle range), the information processing apparatus 1 reduces the screen brightnesses of the internal display and the external display.

Thus, since the face angle at which the screen brightness of the internal display is reduced in the state where the external display is not connected is different from the face angle at which the screen brightnesses of the internal display and the external display are reduced in the state where the external display is connected, the information processing apparatus 1 can perform the screen brightness reduction processing according to the face orientation properly even when the external display is connected.

Further, the information processing apparatus 1 acquires position information indicative of the position of the external display connected to the external connection terminal 130 relative to the internal display. Then, the information processing apparatus 1 sets the angle range of the focus level “High” as the extended angle range based on the position information about the external display.

Thus, in the state where the external display is connected, since the information processing apparatus 1 sets the face angle to reduce the screen brightness based on the position of the external display, the information processing apparatus 1 can perform the screen brightness reduction processing according to the face orientation properly even when the external display is connected.

Specifically, the information processing apparatus 1 sets the angle range of the focus level “High” in the extended angle ranges to widen the angle toward the position of the external display compared to the angle range of the focus level “High” in the reference angle ranges.

Thus, since the angle range of the focus level “High” is widened toward the position of the external display, it becomes difficult for the face angle to be out of the focus level “High” even when the face orientation changes in the direction of the external display. Therefore, even in the state where the external display is connected, since the screen brightness can be suppressed from being reduced by the user using the information processing apparatus 1 while looking at the external display, the information processing apparatus 1 can perform the screen brightness reduction processing according to the face orientation properly.

Further, the information processing apparatus 1 sets the angle range of the focus level “High” in the extended angle ranges to narrow the angle in the direction opposite to the position of the external display compared to the angle range of the focus level “High” in the reference angle ranges.

Thus, since the angle range of the focus level “High” is narrowed in the direction opposite to the direction of the position of the external display, the information processing apparatus 1 can reduce the screen brightness properly in a situation where the user is looking at neither the external display nor the internal display.

Note that when the information processing apparatus 1 sets the angle range of the focus level “High” in the extended angle range, the angle in the direction opposite to the position of the external display compared to that in the angle range of the focus level “High” in the reference angle range may be the same as that of the focus level “High” in the reference angle range (that is, the angle may not be narrowed).

Thus, even in the state where the external display is connected, when the frequency of use of the internal display by the user is high, the information processing apparatus 1 can suppress the screen brightness from being reduced unintentionally due to changes in face operation toward the internal display.

Further, predetermined angle ranges adjacent to the outside of the angle range of the focus level “High” are set as the angle ranges of the focus level “Mid” (an example of third angle ranges). When the angle of the face detected by the face detection processing is within either one of the angle ranges of the focus level “Mid,” the information processing apparatus 1 reduces the screen brightnesses of the internal display and the external display. Further, when the angle of the face detected by the face detection processing is out of both of the angle ranges of the focus level “High” and the focus level “Mid,” the information processing apparatus 1 causes the system to make the transition to the standby state (for example, locks the system).

Thus, when the angle of the face is out of the angle range of the focus level “High,” the information processing apparatus 1 reduces the screen brightness, and when the angle of the face is out of the angle range of the focus level “Mid” (for example, the face is facing back of the information processing apparatus 1), since the information processing apparatus 1 not only reduces the screen brightness but also locks the system, more power can be saved and security can be improved.

Further, when it is detected that the angle of the face detected by the face detection processing is within the angle range of the focus level “High,” the information processing apparatus 1 tracks the face area and the angle of the face in subsequent face detection processing to detect an angle of the face after being out of the angle range of the focus level “High” (for example, an angle of the face that falls into either one of the angle ranges of the focus level “Mid”).

Thus, the information processing apparatus 1 can detect even the angle of the face facing a direction other than forward toward the information processing apparatus 1.

Further, in the face detection processing, when determining that the reliability of the detection results of the face area and the face angle is a predetermined threshold value or more, the information processing apparatus 1 detects the face area and the face angle. When detecting the face angle in the focus level “Mid,” the information processing apparatus 1 lowers the threshold value used for the determination of the above reliability compared to when detecting the face angle within the angle range of the focus level “High.”

Thus, the information processing apparatus 1 can also detect an angle of the face facing a direction other than forward toward the information processing apparatus 1.

Further, a control method for the information processing apparatus 1 according to one or more embodiments includes: a step of causing a processor, such as the face detection unit 210, the CPU 301, and the chipset 303, to perform face detection processing to process image data of a captured image stored in the above memory in order to detect a face area with a face captured therein and an angle of the face from the captured image; and a step of causing the processor to perform brightness reduction processing to reduce the screen brightnesses of the internal display and the external display when the angle of the face detected by the above face detection processing is out of a preset angle range (for example, the angle range of the focus level “High). Then, the setting of the above angle range (for example, the angle range of the focus level “High) used in the above screen brightness reduction processing is different between a state where the external display is not connected to the external connection terminal 130 and a state where the external display is connected to the external connection terminal 130.

Thus, since the control method for the information processing apparatus 1 changes a threshold value (angle range) of the angle of the face for reducing the screen brightness between the state where external display is not connected and the state where the external display is connected, the screen brightness reduction processing according to the face orientation can be performed properly even when the external display is connected.

Note that, in one or more embodiments, the example in which the information processing apparatus 1 reduces the screen brightnesses of both the internal display and the external display in the screen brightness reduction processing in the state where the external display is connected to the external connection terminal 130 is described, but the information processing apparatus 1 may also be configured to reduce the screen brightness of either one of the internal display and the external display. In other words, in the state where the external display is connected to the external connection terminal 130, the information processing apparatus 1 may perform the screen brightness reduction processing (the example of the brightness reduction processing) to reduce either one or both of the screen brightnesses of the internal display and the external display.

For example, in the screen brightness reduction processing in the state where the external display is not connected to the external connection terminal 130, when the angle of the face detected by the face detection processing is out of the angle range of the focus level “High” in the reference angle ranges, the information processing apparatus 1 reduces the screen brightness of the internal display. On the other hand, in the screen brightness reduction processing in the state where the external display is connected to the external connection terminal 130, when the angle of the face detected by the face detection processing is out of the angle range of the focus level “High” in the extended angle ranges, the information processing apparatus 1 reduces the screen brightness of the external display, while when the angle of the face detected by the face detection processing is out of the angle range of the focus level “High” in the reference angle ranges, the information processing apparatus 1 may reduce the screen brightness of the internal display.

Thus, in the state where the external display is connected, the information processing apparatus 1 may apply the extended angle ranges to the screen brightness reduction processing to reduce the screen brightness of the external display, and apply the reference angle ranges to the screen brightness reduction processing to reduce the screen brightness of the internal display. Thus, when the user is mainly looking at the external display and does not look at the internal display much in the state where the external display is connected, the information processing apparatus 1 can reduce the screen brightness of the internal display as much as possible depending on the face orientation.

Further, for example, in the screen brightness reduction processing in the state where the external display is not connected to the external connection terminal 130, when the angle of the face detected by the face detection processing is out of the angle range of the focus level “High” in the reference angle ranges, the information processing apparatus 1 reduces the screen brightness of the internal display. On the other hand, in the state where the external display is connected to the external connection terminal 130 and the external display does not conform to the brightness reduction processing, when the angle of the face detected by the face detection processing is out of the angle range of the focus level “High” in the extended angle ranges, the information processing apparatus 1 may reduce only the screen brightness of the internal display.

Thus, even when the external display does not conform to the screen brightness reduction processing, the information processing apparatus 1 can perform the screen brightness reduction processing on the internal display according to the face orientation both in the state where the external display is connected and in the state where the external display is not connected, respectively.

Note that, in one or more embodiments, the example in which the information processing apparatus 1 sets the extended angle ranges based on the position information about the external display in the state where the external display is connected is described, but it is not limited to this example. For example, in the state where the external display is connected, the information processing apparatus 1 may set the extended angle ranges so that the angle range of the focus level “High” in the extended angle ranges is widen compared to the angle range of the focus level “High” in the reference angle ranges regardless of the position of the external display.

For example, in the state where the external display is connected, the information processing apparatus 1 may set the angle range of the focus level “High” in the extended angle ranges to be widened both to the left and to the right compared to the angle range of the focus level “High” in the reference angle ranges. Further, in the state where the external display is connected, the information processing apparatus 1 may set the angle range of the focus level “High” in the extended angle ranges to be widened both up and down compared to the angle range of the focus level “High” in the reference angle ranges. Further, in the state where the external display is connected, the information processing apparatus 1 may set the angle range of the focus level “High” in the extended angle ranges to be widened in all directions: left, right, up, and down, compared to the angle range of the focus level “High” in the reference angle ranges.

### Second Example

Next, a second example of one or more embodiments will be described.

When one user uses the information processing apparatus 1 by connecting the external display to the information processing apparatus 1, the external display is generally placed near the internal display as illustrated in FIG. 5. However, the external display may also be used when giving a presentation to multiple people. Here, a situation where the external display is used for a presentation is called a “presentation mode.”

In the presentation mode, it is common that the external display is placed far away from the internal display (the information processing apparatus 1). Therefore, if the screen brightness reduction processing is performed according to the angle of the face detected by the information processing apparatus 1, it may happen that the screen brightness is reduced inappropriately. Therefore, in one or more embodiments, an aspect of supporting the screen brightness reduction processing including the presentation mode by setting the screen brightness reduction processing to disabled in a situation where the presentation mode is assumed.

Note that, since the basic configurations of the information processing apparatus 1 according to the second example are the same as the configurations described in the first example, the description thereof will be omitted, and characteristic processing in the second example will be described here.

In the state where the external display is connected to the external connection terminal 130, when the “No attention” information or the “Leave” information is acquired from the face detection unit 210, the brightness reduction processing unit 311 will control the screen brightness reduction processing to disabled if HID input is detected by the HID input detection unit 313 before a certain amount of time passes or the “Attention” information is acquired from the face detection unit 210 before the certain amount of time passes.

In other words, when determining that the angle of face is out of the angle range of the focus level “High” in the extended angle ranges or that no person is present (Leave) based on the detection results by the face detection processing, the brightness reduction processing unit 311 will control the screen brightness reduction processing to disabled if there is HID input before the certain amount of time passes or the angle of the face falls within the focus level “High” in the extended angle ranges before the certain amount of time passes.

Further, in the state where the external display is connected to the external connection terminal 130, when the “No attention” information or the “Leave” information is acquired from the face detection unit 210, the operation control unit 314 will lock the system if HID input is not detected by the HID input detection unit 313 even after the certain amount of time has passed and the “No attention” information is acquired from the face detection unit 210.

In other words, in the state where the external display is connected to the external connection terminal 130, when it is determined that the angle of the face is out of the angle range of the focus level “High” in the extended angle ranges or that no person is present (Leave) based on the detection results by the face detection processing, the operation control unit 314 will lock the system if there is no HID input even after the certain amount of time has passed and the angle of the face is out of the angle range of the focus level “High” in the extended angle ranges.

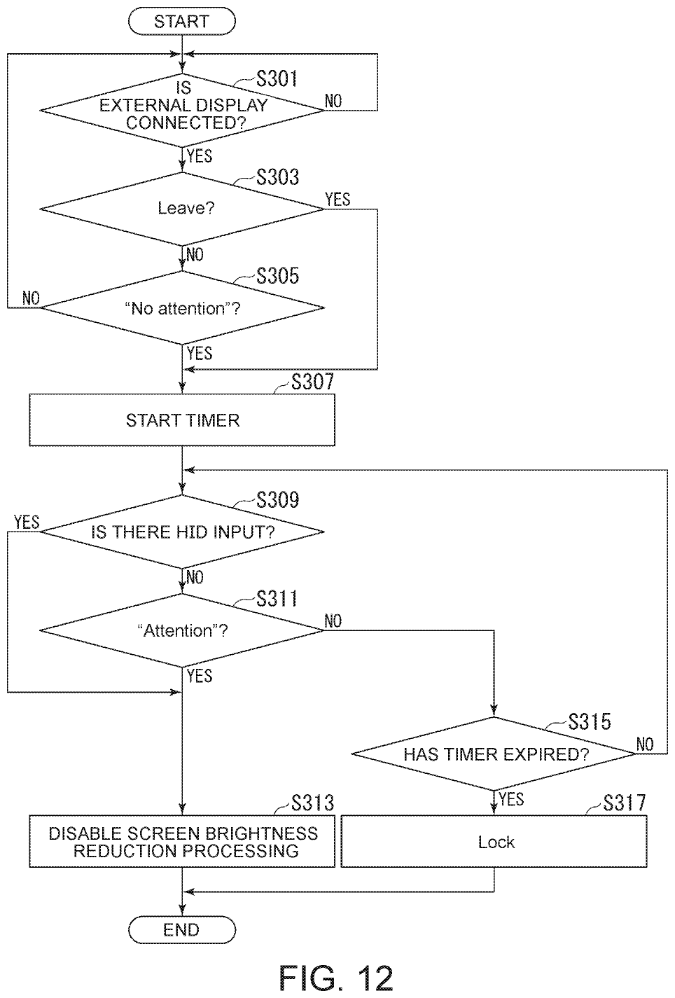

FIG. 12 is a flowchart illustrating an example of processing to deal with the presentation mode in screen brightness reduction processing according to one or more embodiments.

(Step S301) The brightness reduction processing unit 311 acquires, from the connection detection unit 312, information about whether or not the external display is connected to the information processing apparatus 1 to determine whether or not the external display is connected. When determining that the external display is not connected (NO), the brightness reduction processing unit 311 performs the process in step S301 again. On the other hand, when determining that the external display is connected (YES), the brightness reduction processing unit 311 proceeds to a process in step S303.

(Step S303) The brightness reduction processing unit 311 determines whether or not the “Leave” information is acquired from the face detection unit 210. When determining that the “Leave” information is acquired (YES), the brightness reduction processing unit 311 proceeds to a process in step S307. On the other hand, when determining that the “Leave” information is not acquired (NO), the brightness reduction processing unit 311 proceeds to a process in step S305.

(Step S305) The brightness reduction processing unit 311 determines whether or not the “No attention” information is acquired from the face detection unit 210. When determining that the “No attention” information is not acquired (NO), the brightness reduction processing unit 311 returns to the process in step S301. On the other hand, when determining that the “No attention” information is acquired (YES), the brightness reduction processing unit 311 proceeds to the process in step S307.

(Step S307) The brightness reduction processing unit 311 starts measuring time by the timer, and proceeds to a process in step S309.

(Step S309) The brightness reduction processing unit 311 determines whether or not HID input is detected by the HID input detection unit 313. When determining that HID input is detected by the HID input detection unit 313 (YES), the brightness reduction processing unit 311 proceeds to a process in step S313 to disable the screen brightness reduction processing. Thus, when there is HID input even though the user is away or is not looking at the information processing apparatus 1, the screen brightness of the external display is not reduced as being used in the presentation mode. The presentation mode is a mode in which the user is giving a presentation while projecting the screen of the information processing apparatus 1 onto the external display even though the user is away or is not looking at the information processing apparatus 1.

On the other hand, when determining that HID input is not detected by the HID input detection unit 313 (NO), the brightness reduction processing unit 311 proceeds to a process in step S311.

(Step S311) The brightness reduction processing unit 311 determines whether or not the “Attention” information is acquired from the face detection unit 210. When determining that the “Attention” information is acquired (YES), the brightness reduction processing unit 311 proceeds to the process in step S313 to set the screen brightness reduction processing to disabled. Thus, when it is detected that the user is looking at the screen even though the user is away or is not looking at the information processing apparatus 1, the screen brightness of the external display is not disabled as being used in the presentation mode. On the other hand, when the “Attention” information is not acquired (NO), the brightness reduction processing unit 311 proceeds to a process in step S315.

(Step S315) The brightness reduction processing unit 311 determines whether or not the time measurement by the timer has ended (whether or not the certain amount of time has passed). When determining that the time measurement by the timer is not ended (NO), the brightness reduction processing unit 311 returns to the process in step S309. On the other hand, when the brightness reduction processing unit 311 determines that the time measurement by the timer has ended (YES), the procedure proceeds to a process in step S317.

(Step S317) The operation control unit 314 determines that the external display is not used even in the presentation mode, and locks the system. Thus, when such a state that the user is away or is not looking at the information processing apparatus 1 continues without HID input, the operation control unit 314 can lock the system to make the transition to the standby state.

[Summary of Second Example]As described above, in the state where the external display is connected to the external connection terminal 130, when determining that the angle of the face is out of the angle range of the focus level “High” in the extended angle ranges or that no person is present (Leave) based on the detection results by the face detection processing, the information processing apparatus 1 according to one or more embodiments will control the screen brightness reduction processing to disabled if there is HID input before the certain amount of time passes or the angle of the face falls within the focus level “High” in the extended angle ranges before the certain amount of time passes.

Thus, when the information processing apparatus 1 is used in the presentation mode by being connected to the external display, the information processing apparatus 1 can suppress the screen brightness from being reduced by the screen brightness reduction processing.

Further, in the state where the external display is connected to the external connection terminal 130, when determining that the angle of the face is out of the angle range of the focus level “High” in the extended angle ranges or that no person is present (Leave) based on the detection results by the face detection processing, the information processing apparatus 1 will lock the system if there is no HID input after the certain amount of time has passed and the angle of the face is out of the angle range of the focus level “High” in the extended angle ranges.

Thus, in the state where the external display is connected, when such a state that the user is away or is not looking at the information processing apparatus 1 continues with no HID input, the information processing apparatus 1 can lock the system by determining that it is not a situation where the external display is used in the presentation mode.

While the embodiments of this invention have been described in detail above with reference to the accompanying drawings, the specific configurations are not limited to those in the embodiments described above, and design changes are also included without departing from the scope of this invention. For example, the respective components described in the above-described embodiments can be combined arbitrarily.

Further, in the aforementioned embodiments, the configuration example in which one external display (external display device 5) is connected to the information processing apparatus 1 is described, but two or more external displays may also be connected.

Further, the CPU 301 and the chipset 303 may be configured as individual processors, or configured to be integrated as one processor.

Further, in the aforementioned embodiments, the example in which the face detection unit 210 is provided separately from the CPU 301 and the chipset 303 is illustrated, but some or all of the functions of the face detection unit 210 may be provided in the chipset 303, or may be provided in a processor integrated with the CPU 301 or the chipset 303. For example, the CPU 301, the chipset 303, and the face detection unit 210 may be configured as individual processors, respectively, or may be configured to be integrated as one processor. Further, some or all of the functions of the face detection unit 210 may be provided in the EC 200. Further, part of the system processing unit 310 may be provided in the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or the functions of the information processing apparatus 1 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of the aforementioned embodiments is not limited to the laptop PC, which may also be, for example, a desktop PC or the like.

### DESCRIPTION OF SYMBOLS

1 information processing apparatus

10 first chassis

20 second chassis

15 hinge mechanism

110 display unit (internal display)

120 imaging unit

130 external connection terminal

140 power button

150 input device

151 keyboard

153 touch pad

160 communication unit

170 storage unit

200 EC

210 face detection unit

211 face detection processing unit

212 angle range setting unit

213 detection result output unit

300 main processing unit

301 CPU

302 GPU

303 chipset

304 system memory

310 system processing unit

311 brightness reduction processing unit

312 connection detection unit

313 HID input detection unit

314 operation control unit

400 power supply unit

510 display unit (external display)

1. An information processing apparatus comprising:
a memory which temporarily stores image data of an image captured by an imaging unit;
a processor which processes the image data stored in the memory;
an internal display; and
a connection unit which connects to an external display, wherein
the processor performs
face detection processing to process the image data of the image stored in the memory in order to detect a face area with a face captured therein and an angle of the face from the image, and
brightness reduction processing to reduce screen brightness of either one or both of the internal display and the external display when the angle of the face detected by the face detection processing is out of a preset angle range, and
a setting of the angle range used in the brightness reduction processing is different between a state where the external display is not connected to the connection unit and a state where the external display is connected to the connection unit.

2. The information processing apparatus according to claim 1, wherein
in the brightness reduction processing in the state where the external display is not connected to the connection unit, when the angle of the face detected by the face detection processing is out of a preset first angle range, the processor reduces the screen brightness of the internal display, and
in the brightness reduction processing in the state where the external display is connected, when the angle of the face detected by the face detection processing is out of a second angle range different from the first angle range, the processor reduces the screen brightnesses of the internal display and the external display.

3. The information processing apparatus according to claim 1, wherein
in the brightness reduction processing in the state where the external display is not connected to the connection unit, when the angle of the face detected by the face detection processing is out of a preset first angle range, the processor reduces the screen brightness of the internal display, and
in the brightness reduction processing in the state where the external display is connected, when the angle of the face detected by the face detection processing is out of a second angle range different from the first angle range, the processor reduces the screen brightness of the external display, while when the angle of the face detected by the face detection processing is out of the first angle range, the processor reduces the screen brightness of the internal display.

4. The information processing apparatus according to claim 1, wherein
in the brightness reduction processing in the state where the external display is not connected to the connection unit, when the angle of the face detected by the face detection processing is out of a preset first angle range, the processor reduces the screen brightness of the internal display, and
in the state where the external display is connected to the connection unit and the external display does not conform to the brightness reduction processing, when the angle of the face detected by the face detection processing is out of a second angle range different from the first angle range, the processor reduces the screen brightness of the internal display.

5. The information processing apparatus according to claim 2, wherein the processor acquires position information indicative of a position of the external display connected to the connection unit relative to the internal display, and sets the second angle range based on the position information about the external display.

6. The information processing apparatus according to claim 5, wherein the processor sets the second angle range to widen the angle toward the position of the external display compared to the first angle range.

7. The information processing apparatus according to claim 6, wherein the processor sets the second angle range to narrow the angle in a direction opposite to the position of the external display compared to the first angle range.

8. The information processing apparatus according to claim 2, wherein
predetermined angle ranges adjacent to an outside of the first angle range or the second angle range are set as third angle ranges, and
when the angle of the face detected by the face detection processing is within either one of the third angle ranges, the processor reduces either one or both of the screen brightnesses of the internal display and the external display, and when the angle of the face is out of all of the first angle range, the second angle range, and the third angle ranges, the processor causes a system to make a transition to a standby state.

9. The information processing apparatus according to claim 8, wherein when it is detected that the angle of the face is within the first angle range or the second angle range, the processor tracks the face area and the angle of the face in subsequent face detection processing to detect an angle of the face after being out of the first angle range or the second angle range.

10. The information processing apparatus according to claim 8, wherein
in the face detection processing, when determining that reliability of detection results of the face area and the angle of the face is a predetermined threshold value or more, the processor detects the face area and the face angle, and
when detecting the angle of the face within either one of the third angle ranges, the processor lowers the threshold value used for determination of the reliability compared to when detecting the angle of the face within the first angle range or the second angle range.

11. The information processing apparatus according to claim 2, wherein in the state where the external display is connected to the connection unit, when determining that the angle of the face is out of the second angle range or that no person is present based on detection results by the face detection processing, the processor will control the brightness reduction processing to disabled if there is user input before a certain amount of time passes or the angle of the face falls within the second angle range before the certain amount of time passes.

12. The information processing apparatus according to claim 2, wherein in the state where the external display is connected to the connection unit, when determining that the angle of the face is out of the second angle range or that no person is present based on detection results by the face detection processing, the processor will lock a system if there is no user input and the angle of the face is out of the second angle range even after a certain amount of time has passed.

13. A control method for an information processing apparatus including: a memory which temporarily stores image data of an image captured by an imaging unit; a processor which processes the image data stored in the memory; an internal display; and a connection unit which connects to an external display, the control method comprising:
a step of causing the processor to perform face detection processing to process the image data of the image stored in the memory in order to detect a face area with a face captured therein and an angle of the face from the image; and
a step of causing the processor to perform brightness reduction processing to reduce screen brightness of either one or both of the internal display and the external display when the angle of the face detected by the face detection processing is out of a preset angle range,
wherein a setting of the angle range used in the brightness reduction processing is different between a state
where the external display is not connected to the connection unit and a state where the external display is connected to the connection unit.
